(19) United States
(12) Patent Application Publication
(10) Pub. No.: US 2006/0174051 A1
(43) Pub. Date: Aug. 3, 2006

(54) Method and apparatus for a redundancy approach in a processor based controller design

(75) Inventors: Angela L. Lordi, Lansdale, PA (US); Jay W. Gustin, Scottsdale, AZ (US); W. Russell Massey, Levittown, PA (US); Paul Gerhart, North Wales, PA (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/050,320

(22) Filed: Feb. 2, 2005

(51) Int. Cl. G06F 13/36

(52) U.S. Cl. 710/314

(57) ABSTRACT

A system for handling data of a process with a primary controller and a redundant controller. The primary controller includes a primary processor that is operable to perform tracking data tasks by using a low speed bus to cooperate with a tracker controller for storage of tracking data in a tracker memory. The primary processor is further operable to perform other tasks by using a high speed bus in cooperation with a primary memory. The second bus has an operating rate considerably higher (for example, a factor of two or more) than that of the first bus.

### RELATED APPLICATION

The present patent application is related to U.S. patent application Ser. No. ______, entitled “METHOD AND APPARATUS FOR REDUCING MEMORY AND COMMUNICATION ACTIVITY IN A REDUNDANT PROCESS CONTROLLER WITH CHANGE-DRIVEN MEMORY IMAGING, THROUGH OPTIMIZATION OF UNCHANGING DATA” (120 05207) by Jay W. Gustin et al, filed on even date herewith and assigned to Honeywell Inc., the assignee of the present application.

### BACKGROUND OF THE INVENTION

1. Field of the Invention

The present invention relates to a method and an apparatus for updating a secondary database of a redundant processor in a process control system, and more particularly, to an apparatus for tracking changes of predetermined data of a primary database for subsequent updating of a secondary database.

2. Discussion of Background Art

Redundant process control systems generally include one or more redundant controller nodes that monitor signals of or provide control signals to the process control system. A redundant controller node includes a primary controller and a secondary controller. The primary controller includes a primary processor, a primary database and a primary tracking unit and the secondary controller includes a secondary controller, a secondary database and a secondary tracking unit. When the primary controller is active so as to monitor signals of and/or provide control signals to the process control system, the secondary controller is idle and vice-a-versa. The primary tracking unit tracks the process data being handled by the primary controller and periodically furnishes changes of the data to the secondary controller. When an event that requires a change over occurs, the secondary database contains the updated process data. Thus, the secondary controller is prepared to takeover and act as the primary controller of the node. The failed controller can then be repaired and prepared to assume the role of the secondary controller.

In some known primary controllers (for example, U.S. Pat. No. 6,170,044) the primary tracking unit is connected to a bus that is used by the primary processor to access the primary database. This requires that the bus be shared with the normal process data handling function of the primary processor as well as with the tracking unit functions. This affects the traffic on the bus and reduces the bandwidth available for other processing activities of the primary processor. This physical package requires splitting the functions across two printed circuit boards. An expensive, high-pin-count connector between the boards carries the full complement of primary bus signals and primary bus, with duplicate interface logic on each board.

Thus, there is a need for an improved bandwidth process controller that does not require an expensive, large connector.

### SUMIMARY OF THE INVENTION

A system of the present invention for controlling or monitoring a process comprises a primary controller and a redundant controller. The primary controller comprises a primary processor, a primary memory, a tracker controller and a tracking memory. A first bus interconnects the primary processor and the tracker controller. The primary processor is operable to perform tracking data tasks and, using the first bus, to cooperate with the tracker controller for storage of the tracking data in the tracking memory and to transfer the tracking data to the redundant controller. A second bus interconnects the primary processor and the primary memory. The primary processor further is operable to perform tasks other than the tracking data tasks using the second bus and the primary memory.

Preferably, the other tasks are selected from the group consisting of: an operating system, one or more algorithms involving calculations, a communications application, an input/output application, alarm and event generation, diagnostics and any combination thereof.

Preferably, the second bus has an operating rate that is higher than the operating rate of the first bus. More preferably, the operating rate of the second bus exceeds the operating rate of the first bus by a factor of two or more.

In another embodiment of the system of the present invention, the primary processor, the second bus and the primary memory are located on a first printing wiring board. The tracker controller and the tracking memory are located on a second printed wiring board. The first bus has a first portion and a second portion located on the first and second printed wiring boards, respectively. A low cost, low-pin-count connector connects the first and second portions.

A method of the present invention operates a primary controller that is backed up by a redundant controller. The method tracks data tasks with a primary processor that cooperates via a first bus with a tracker controller for storage of tracking data in a tracking memory and transfer of the tracking data to the redundant controller. Other tasks are performed with the primary processor that cooperates via a second bus with a primary memory.

Preferably, the other tasks are selected from the group consisting of: an operating system, one or more algorithms involving calculations, a communications application, an input/output application, alarm and event generation, diagnostics and any combination thereof.

Preferably, the second bus has an operating rate that is higher than an operating rate of the first bus. More preferably, the operating rate of the second bus exceeds the operating rate of the first bus by a factor or two or more.

In one embodiment of the method, the tracking data is formatted with message headers and sized for use as Ethernet redundancy private link frames before being transferred to the redundant controller.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a block diagram of a process control system that includes the redundant controller of the present invention;

FIG. 2 is a block diagram of the primary tracker controller of the redundant controller of the FIG. 1 system;

FIG. 3 depicts a format of the buffers of the primary tracking memory of FIG. 2; and

FIGS. 4 and 5 are process flow diagrams of the operation of the redundant controller of the FIG. 1 system.

### DESCRIPTION OF THE PREFERRED EMBODIMENT

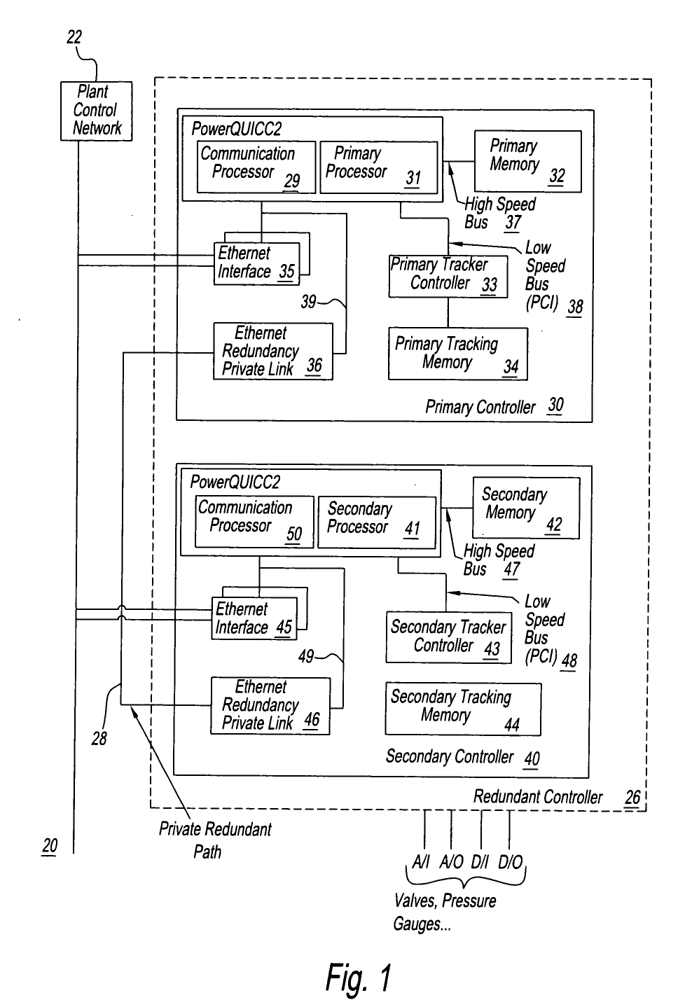

Referring to FIG. 1, a process control system 20 includes a plant control network 22 that is interconnected to one or more redundant controllers 26. Only one redundant controller 26 is shown by way of example. It will be apparent to those of ordinary skill in the art that a plurality of redundant controllers 26 may be connected to plant control network 22 according to the present invention. Redundant controller 26 includes a primary controller 30 and a secondary controller 40. Controllers 30 and 40 are identical except for role. For the purpose of the present description, it is assumed that primary controller 30 is active and secondary controller 40 is inactive or idle. It will be apparent to those skilled in the art that when the roles of controllers 30 and 40 are reversed to idle and active, respectively, controller 40 becomes the primary controller and controller 30 becomes the secondary controller. Primary controller 30 and secondary controller 40 are interconnected via a private link 28.

Primary controller 30 includes a communication processor 29 (which provides the Ethernet Media Access Layer) a primary processor 31, a primary memory 32, a primary tracker controller 33, a primary tracking memory 34, one or more Ethernet interface units 35 and a private Ethernet redundancy link 36. A high-speed bus 37 interconnects primary processor 31 and primary memory 32. A low-speed bus 38, for example, a Peripheral Component Interconnect (PCI) bus (Industry Standard), interconnects primary processor 31 with primary tracker controller 33, which operates primary tracking memory 34. Except as described below, primary tracking memory 34 behaves as an ordinary read/write memory. A communication bus 39, which can use media independent interfaces (Industry Standard) connects primary processor 31 with Ethernet interfaces units 35 and Ethernet redundancy private link 36. The operating rate of high speed bus 37 exceeds the operating rate of low speed bus 38 by a factor of at least two, more preferably three and most preferably six. Ethernet interface units 35 are connected to plant control network 22. Private redundancy link 36 is connected to private link 28. Primary tracking memory 34 is preferably battery backed for preservation of data through power failure. In one example, low-speed bus 38 requires one-third the number of signals of the high-speed bus 37, thus permitting the use of a low-cost, low-pin-count inter-board connector.

Secondary controller 40 includes secondary communication processor 50 (which provides the Ethernet Media Access Layer), a secondary processor 41, a secondary memory 42, a secondary tracker controller 43, a secondary tracking memory 44, one or more Ethernet interface units 45 and a private Ethernet redundancy link 46. A high-speed bus 47 interconnects secondary processor 41, and secondary memory 42. A low-speed bus 38, for example, a Peripheral Component Interconnect (PCI) bus (Industry Standard). interconnects secondary processor 41 with secondary tracker controller 43, which operates secondary tracking memory 44. The secondary tracking memory 44 behaves as an ordinary read/write memory. A communication bus 49, which can use media independent interfaces (industry standard), connects communication processor 50 with Ethernet interfaces units 45 and Ethernet redundancy private link 46. The operating rate of high speed bus 47 exceeds the operating rate of low speed bus 48 by a factor of at least two, more preferably three and most preferably six. Ethernet interface units 45 are connected to plant control network 22. Private redundancy link 46 is connected to private link 28. Secondary tracking memory 44 is preferably battery backed for preservation of data through power failure. Low-speed bus 48 requires one-third the number of signals of the high-speed bus 47, thus permitting the use of a low-cost, low-pin-count inter-board connector.

Coupled to redundant controller 26 are various inputs and outputs including analog inputs (A/I), analog outputs (A/O), digital inputs (D/I), and digital outputs (D/O) that are connected to various valves, pressure switches, pressure gauges, thermocouples that are used to indicate the current information or status and to control the process of process control system 10. Plant control network 22, for example, can be of the type described in published U.S. Patent Application No. US2002/00046357. Although not shown, it is understood that the various analog and digital inputs and outputs are connected via one or more appropriate interface units, for example, an I/O link, to primary processor 31 and secondary processor 41.

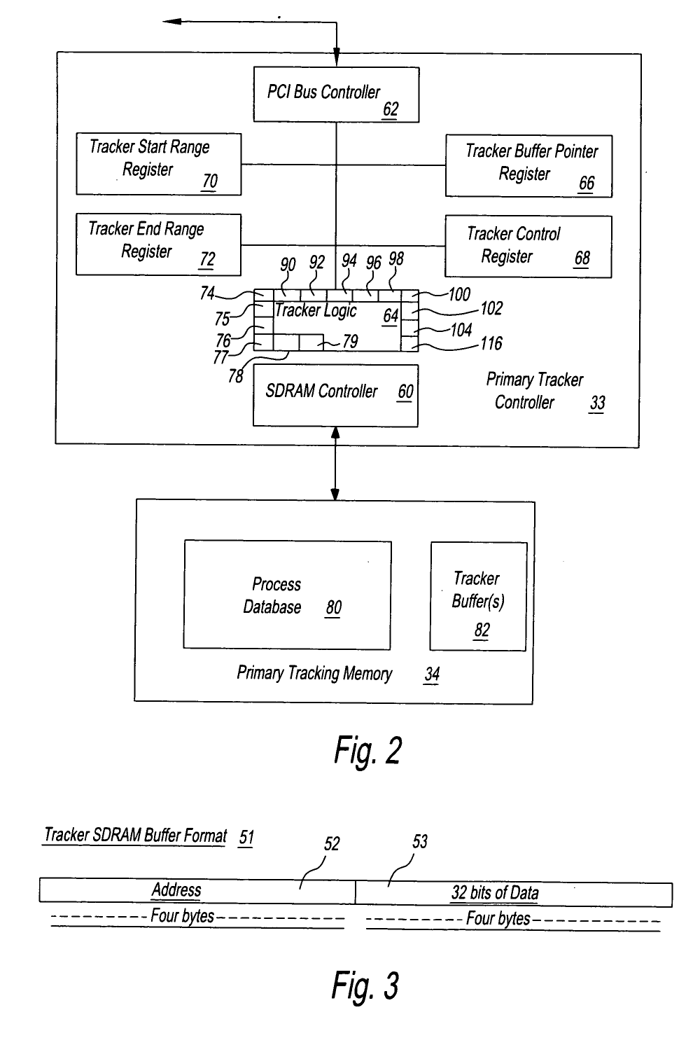

During initialization of redundant controller 26, the determination of which controller 30 or 40 is to be the primary or secondary, is determined by a download control personality (i.e., command information) from plant control network 22. At that time one of the controllers 30 or 40 will be the primary controller and the other will take the role of the secondary controller 40. Primary controller 30 performs the control processing algorithms, which include reading the input data from the valves, pressure gauges, performing predetermined calculations and outputting the results. Primary processor 31 stores the data of these operations in a process database 80 (FIG. 2), residing in primary tracking memory 34 via low-speed bus 38. Primary tracker controller 33 also detects changes in the data written to process database 80 and creates a record of these changes in one or more tracker buffers 82 (FIG. 2), residing in primary tracking memory 34.

Also, upon initialization of redundant controller 26, a copy of the contents of the designated range of primary tracking memory 34 is downloaded to secondary tracking memory 44 by facilities that are discussed U.S. Pat. No. 6,170,044, the contents of which is hereby incorporated by reference.

After initialization, primary tracking controller 33 updates primary tracking memory 34 with changes to the data being tracked. That is, primary processor 31 is operable to perform tracking data tasks by placing the data being tracked (tracking data) on low-speed bus 38. Primary tracker controller 33 captures this data for storage in primary tracking memory 34. If the captured data requires a change to the data currently stored in process database 80, the data is also stored in tracker buffers 82. When a predetermined amount of data has been accumulated in the tracker buffers 82, primary tracker controller 33 provides an interrupt. Primary processor 31 responds to the interrupt to transfer the data from the tracker buffers 82 via Ethernet redundancy private link 36 and link 28 to secondary controller 40. At the end of each increment of primary controller control execution, the primary controller uses the Ethernet redundancy private link 36 to the secondary controller 40 so that a consistent set of data has been sent. Secondary controller 40 verifies that all data has been received, then uses the transferred data to update secondary tracker memory 44 and secondary memory 42. The primary controller is then able to perform the next increment of control processing.

Primary processor 31 is further operable to perform tasks other than tracking data tasks by using high speed bus 37 in conjunction with primary memory 32. These other tasks, for example, include an operating system, one or more algorithms involving calculations, a communications application, an input/output application, alarm and event generation, diagnostics and any combination thereof. By using high bus 37 rather than low speed bus 38 as in prior process controllers, the performance of primary controller 30 is enhanced. The bandwidth of high speed bus 37 is not limited by the tracking data tasks.

Primary and secondary controllers 30 and 40 can communicate to each other via three mediums, plant control network 22, private link 28 and an I/O link (not shown). The I/O link is a path to which primary processor 31 and secondary processor 41 are connected in order to interface with the A/I, A/O, D/I and D/O inputs/outputs. Via these communication paths, primary controller 30 can ensure that secondary controller 40 is present and operational. Also, via these paths, secondary controller 40 can test that primary controller 30 is operational in order to determine when it is to assume the primary status (or mode).

Primary processor 31 manages the analog inputs and outputs A/I and A/O and the digital inputs and outputs D/I and D/O, processes such inputs and outputs in accordance with control algorithms and updates primary tracking memory 34 as needed based on these activities as well as others. Primary processor 31 places the data being tracked on low speed bus 38 in the form of an address in primary tracking memory 32 and the data to be stored at that address.

Referring to FIG. 2, primary tracker controller 33 includes a Synchronous Dynamic Random Access Memory (SDRAM) controller 60, a PCI bus controller 62, a tracker logic 64, a tracker buffer pointer register 66, a tracker control register 68, a tracker start range register 70 and a tracker end range register 72.

Primary tracking memory 34, which is preferably an SDRAM, includes a process database 80 in which the tracked data is stored and one or more tracker buffers 82 in which a record of changes to process database 80 is stored. SDRAM controller 60 controls accesses to primary tracking memory 34 for read and write cycles. SDRAM controller 60 preferably performs each write cycle as a read-modify-write cycle.

Tracker start range register 70 and tracker end range register 72 are used to define a tracked address range, (tracked memory) in process database 80 of primary tracking memory 34. The beginning of the tracked address range is determined by writing to tracker start range register 70. The end of the address range is determined by writing to tracker end range register 72. Tracker buffer pointer register 66 is used to define the address in tracker buffer 82 (buffer memory) to store the tracked information. Tracker control register 68 is used to configure and control the operation of tracking logic 64. Tracker buffer 82 is the repository for information captured during tracked bus cycles.

Primary tracker controller 33 operates by performing reads and writes requested on low speed bus 38 by primary processor 31 and Ethernet redundancy private link 36. Reads and writes to any addresses in primary tracking memory 34 are controlled by SDRAM controller 60. Primary tracker controller 33 also creates information packets for writes on low speed bus 38 that fall within the tracked address range. An information packet comprises a address, and 32 bits of data.

The captured information packet is written to tracker buffer 82 under control of SDRAM controller 60. Tracker buffer pointer register 66 is used in conjunction with tracker logic 64 as an address generator for the cycles that store the information packets to tracker buffer 82.

To conserve bandwidth and improve speed of transferring updates to secondary controller 40, only information packets containing changes to process database 80 are stored in tracker buffer 82. This reduces the amount of data to be transferred to secondary controller 40 when only a portion of a data structure is modified, or the same value is repeatedly stored by a control algorithm. After the read portion of the read-modify-write cycle for process database 80, one or more bytes of the read data are replaced with the designated bytes of the write data. This composite data to be written is compared with the data read. If the composite write data is identical to the read data, the captured data is written to process database 80, but is not written to tracker buffer 82. On the other hand, if the composite write data and the read data are not identical, the composite write data is written to both process database 80 and to tracker buffer 82.

Tracker buffer pointer register 66 is used by SDRAM controller 60 as an address register to write the data changes to tracker buffer 82. Tracker logic 64 generates a tracker interrupt 116 every time buffer pointer register 66 rolls over a buffer end address (for example, 1496 bytes, which represents a 32-byte message header and 183 information packets). Tracker interrupt 116 causes primary processor 31 to initiate a transfer of the contents of tracker buffer 82 to secondary controller 40. Tracker buffer pointer register 66 is then incremented by 32 bytes to make room for a message header. At this point, primary tracker controller 33 is ready to handle another operation of low speed bus 38.

PCI bus controller 62 contains the logic to interface to low speed bus 38 and responds to data and commands placed on low speed bus 38 by primary processor 31. During initialization, primary processor 31 places a copy of the contents of the designated range of primary memory 32 and the start and end addresses of the range on low speed bus 38. PCI bus controller 62 responds by decoding the commands for the low speed bus 38. PCI bus controller 62 in conjunction with tracker logic 64 checks to see if the current low speed bus cycle is a write cycle and if it is within the address range defined by the contents of tracker start range register 70 and tracker end range register 72. If the current low speed bus cycle is decoded to be a write cycle and within the tracker address range, tracker logic 64 and SDRAM controller 60 start the process to update process database 80 and tracker buffer 82 in primary tracking memory 34. Tracker logic 64 and SDRAM controller 60 write the data presented on low speed bus 38 to process database 80 and data to be tracked to tracker buffer 82.

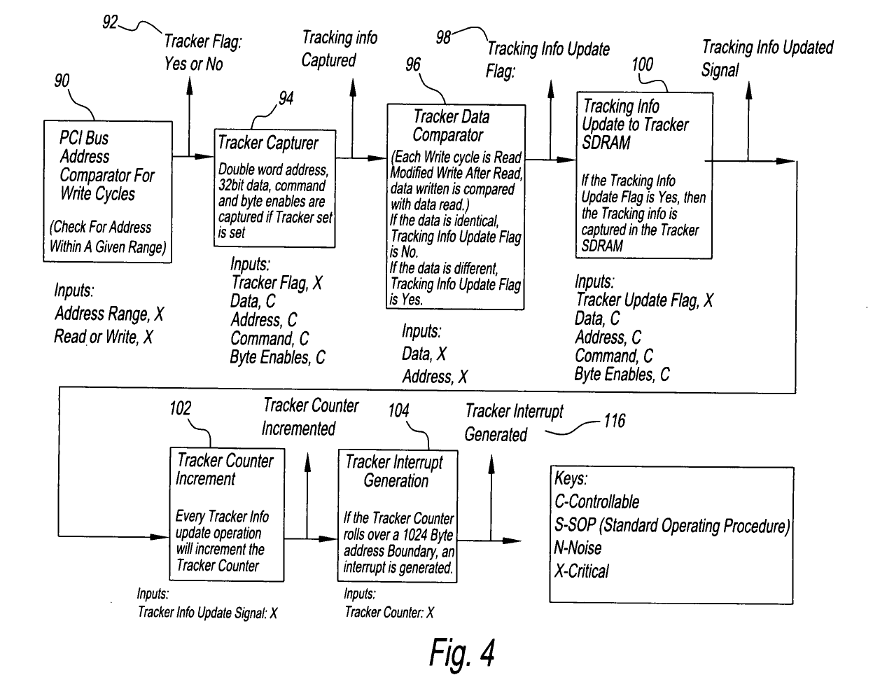

Referring to FIG. 3, the data to be tracked is stored in buffer 82 in a tracker buffer SDRAM format 51 that includes an address field 52 and a data field 53, each of which is shown as having four bytes, by way of example, with each byte having eight bits. All four bytes of data field 53 are significant regardless of how many bytes were actually written by primary processor 31 as the data capture for partial word writes occurs during the write portion of the SDRAM Read-Modify-Write sequence.

Referring to FIGS. 2, 4 and 5, tracker logic 64 includes an address comparator 74, a tracker capturer 75, a tracker data comparator 76, a tracker SDRAM mechanism 77, a tracker counter increment 78, a tracker flag 92, a tracking information update flag 98 and a tracker interrupt 116. Tracker logic 64 also includes the logic of boxes 90, 94, 96, 100, 102 and 104.

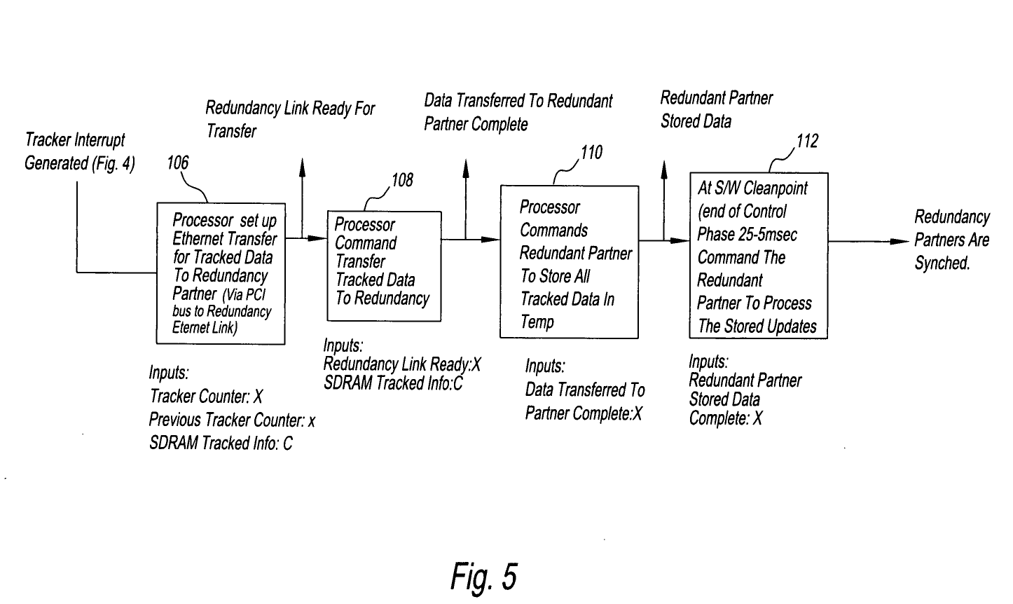

Referring to FIGS. 4 and 5, the operation of primary tracker controller 33 will be described for tracker operation. Primary processor 31 runs software applications concerning communications with plant control network 22, data gathering, device controlling and processing results thereof using primary memory 32 and high speed bus 37. From time to time, primary processor 31 places on low speed bus 38 an information packet that includes data and an associated address to be written, as well as an indication of whether the cycle is a read or a write cycle. The data appears on the low speed bus 38 as writes of one to four bytes.

At box 90 an address of a current information write packet on low speed bus 38 is compared in address comparator 74 with the start and end addresses in tracker start range register 70 and tracker end range register 72 to determine if the current address falls within the designated range. If a read, but not a write, falls within the designated range, the tracking logic is bypassed and the requested operation is performed by SDRAM controller 60.

Tracker logic 64 ignores read cycles and starts the address comparison on write cycles. If the current PCI bus cycle is a write cycle and falls within the given address range specified by tracker start range register 70 and tracker end range register 72, tracker flag 92 is set to indicate that this cycle should start the tracking process. If tracker flag 92 is not set, then the address and data are ignored. If yes, then PCI bus controller 62 along with the tracker logic 64 captures the current information packet at box 94.

At box 96, tracker data comparator compares the new or current data of the current information packet with the read data from process database 80. Tracking logic 64 responds to the comparison to control the setting of tracking information update flag 98. If the current data and the read data are identical, then tracking information update flag 98 is set to No. For this case, the current data is not written to tracker buffer 82.

If the current data and the read data are not identical, then tracking info update flag 98 is set to Yes. For this case, the current information packet is stored in tracker buffer 82 at the address indicated by tracker buffer pointer register 66 as indicated at box 100. Tracker logic 64 then updates (e.g., increments) tracker buffer pointer register 66 as indicated at box 102. Also, tracker logic 64 determines if tracker buffer pointer register 66 rolls over a 1496 byte address boundary and if so, generates tracker interrupt 116 as indicated at box 104. If tracker interrupt 116 is not generated, then the operation for the current information packet is complete.

If tracker interrupt 116 is generated, thenprimary processor 31 sets up an Ethernet transfer for the tracked data the contents of tracker buffer 82 via communication bus 39 to Ethernet redundancy link 36 as indicated by box 106. Primary processor 31 then issues a command to transfer the tracked data via private redundancy path 28 to secondary controller 40 as indicated by box 108. Primary processor 31 then commands secondary controller 40 to store the transferred tracker data in a temporary buffer (not shown) of secondary tracking memory 44 as indicated at box 110. Subsequently, primary processor 31 commands secondary controller 40 to process the stored tracker data as indicated at box 112. When secondary controller has processed the transferred tracker data, primary and secondary controllers 30 and 40 are data synchronized.

Process controller redundancy is not dependent on private link 28 remaining operational. If private link 28 becomes non-functional, then the tracking information in tracking buffers 80, being formatted for use as Ethernet packets, can be sent by primary controller 30 to secondary controller 40 over plant control network 22. Because the bandwidth of plant control network 22 is less available than the bandwidth of redundancy private link 28, this use is limited to the case where primary redundancy private link interface 36 becomes non-functional. A one-time synchronization may be commanded, followed by switchover. The role of secondary controller 40 is then changed from secondary to primary. The old primary controller 30 is then replaced with a functional unit.

The present invention having been thus described with particular reference to the preferred forms thereof, it will be obvious that various changes and modifications may be made therein without departing from the spirit and scope of the present invention as defined in the appended claims.

What is claimed is:

1. A system for controlling or monitoring a process comprising:
a primary controller and a redundant controller;
said primary controller comprising:
a primary processor, a primary memory, a tracker controller and a tracking memory;
a first bus that interconnects said primary processor and said tracker controller, wherein said primary processor is operable to perform tracking data tasks and, using said first bus, to cooperate with said tracker controller for storage of said tracking data in said tracking memory and to transfer said tracking data to said redundant controller, and
a second bus that interconnects said primary processor and said primary memory, wherein said processor further is operable to perform tasks other than said tracking data tasks using said second bus and said primary memory.

2. The system of claim 1, wherein said other tasks are selected from the group consisting of: an operating system, one or more algorithms involving calculations, a communications application, an input/output application, alarm and event generation, diagnostics and any combination thereof.

3. The system of claim 1, wherein said second bus has an operating rate that is higher than an operating rate of said first bus.

4. The system of claim 3, wherein said operating rate of said second bus exceeds said operating rate of said first bus by a factor of two or more.

5. The system of claim 1, wherein said primary processor, said second bus and said primary memory are located on a first printing wiring board, wherein said tracker controller and said tracking memory are located on a second printed wiring board, wherein said first bus has a first portion and a second portion located on said first and second printed wiring boards, respectively, and wherein a low cost, low-pin-count connector connects said first and second portions.

6. A method for operating a primary controller that is backed up by a redundant controller, said method comprising:
performing tracking data tasks with a primary processor that cooperates via a first bus with a tracker controller for storage of tracking data in a tracking memory and transfer of said tracking data to said redundant controller; and
performing other tasks with said primary processor that cooperates via a second bus with a primary memory.

7. The method of claim 6, wherein said other tasks are selected from the group consisting of: an operating system, one or more algorithms involving calculations, a communications application, an input/output application, alarm and event generation, diagnostics and any combination thereof.

8. The method of claim 6, wherein said second bus has an operating rate that is higher than an operating rate of said first bus.

9. The method of claim 8, wherein said operating rate of said second bus exceeds said operating rate of said first bus by a factor of two or more.

10. The method of claim 6, wherein said tracking data is formatted with message headers and sized for use as Ethernet redundancy private link frames before being transferred to said redundant controller.
